(19) United States
(12) Patent Application Publication
(10) Pub. No.: US 2006/0220414 A1
(43) Pub. Date: Oct. 5, 2006

(54) Vehicle door panel and component assembly mounted through the panel

(75) Inventor: Stan P. Boyer, Zeeland, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company, Plymouth, MI (US)

(21) Appl. No.: 10/541,667

(22) PCT Filed: Jan. 7, 2003
(86) PCT No.: PCT/US03/00419

§ 371 Date: Jan. 31, 2006

(51) Int. Cl. B60J 5/00

(52) U.S. Cl. 296/146.7

(57) ABSTRACT

Assembly (12) includes a substrate (18) having an aperture (60) extending through the substrate (18) and having a first capping portion (62, 162, 362, 462) at least partially about the aperture (60), a skin (25) having a second capping portion (64, 164, 364, 464), at least one layer (35) between the substrate (18) and the skin (25) and a component (24) extending through the aperture (60). The first capping portion (62, 162, 362, 462) and the second capping portion (64, 164, 364, 464) cooperatively engage one another to close off the at least one compressible layer (35) between the substrate (18) and the skin (25). A method for manufacturing the panel (16) is also disclosed.

### CROSS-REFERENCE TO RELATED PATENT APPLICATIONS

The present application is related to co-pending U.S. patent application Ser. No. 09/801,369 filed on Mar. 7, 2001 by Pokorzynski et al., and entitled “Foam-In Place Seal and Method”, the entire disclosure of which is hereby incorporated by reference.

### FIELD OF THE INVENTION

The present invention relates to vehicle interior components having a foam-filled panel. In particular, the present invention relates to a foam-filled panel having an aperture through which a mounted component extends.

### BACKGROUND OF THE INVENTION

Padded or cushioned vehicle interior components or panels, such as the instrument panel, door panels and the like, have been made by providing a powdered PVC slush-molded skin which is held in place over a substrate and back-filled with a urethane foam material in an injection process in which the edges of the skin is sealed using a plurality of clamps for providing a finished product in which the skin, with the padded foam backing, is bonded to an original substrate, such as the edges of a door panel, the edges of an instrument panel, or the like. Although such a process results in a suitable product, the cost of manufacturing molds with the multiple seals for the edges of the skin to prevent the escape of the backing foam material is prohibitive. As a result, the process typically has only been used in luxury vehicles where the additional expense can be supported.

In many vehicles, a component such as a door latch must pass through the cushioned panel. Because it is difficult if not impossible to clamp the edges of the skin about a relatively small aperture formed in the substrate prior to the injection process, the aperture is typically created after the cushioned panel is manufactured pursuant to the above-described process. This is usually achieved by cutting through the skin, the foam material and the substrate to form the aperture. Unfortunately, this results in exposure of the foam material about the opening. This problem is typically solved by positioning a rigid bezel or trim cover which overlies the skin about the opening and which conceals the foam about the aperture. The bezel is typically mounted to the panel by additional holes, cut or drilled through the skin, the foam and the substrate around the aperture. The bezel includes bosses that are inserted through the additional holes. The vehicle component is then passed through the aperture and secured by fasteners screwed into the bezel bosses.

The above-described process undesirably creates a rigid surface around the aperture and adjacent to the component. In addition, cutting the aperture and cutting or drilling the holes about the aperture may weaken the integrity of the foam and reduce the strength of the panel about the aperture. Moreover, the process is expensive and time consuming to perform.

### SUMMARY OF THE INVENTION

According to one aspect of the present invention, a panel for use in an assembly having a mounted component includes a substrate, a skin and at least one compressible layer between the substrate and the skin. The substrate has an aperture extending through the substrate and a first capping portion extending at least partially about the aperture. The aperture is configured to receive the mounted component. The skin has a second capping portion at least partially about the aperture. The first capping portion and the second capping portion cooperatively engage one another to close off the at least compressible layer between the substrate and the skin.

According to another aspect of the present invention, an assembly includes a substrate, a skin, at least one layer between the substrate and the skin, and a component. The substrate has an aperture extending through the substrate and a first capping portion extending at least partially about the aperture. The component extends through the aperture. The skin has a second capping portion. The first capping portion and the second capping portion cooperatively engage one another to close off the at least one layer between the substrate and the skin.

According to another aspect of the present invention, a vehicle door assembly includes a substrate, a handle and a compressible surface. The substrate has an aperture extending through the substrate. The handle extends through the aperture and has a portion opposite the substrate. The compressible surface is coupled to the substrate and extends in close proximity to the aperture between the substrate and the portion of the handle opposite the substrate.

According to another aspect of the present invention, a method for manufacturing a panel for use with an assembly having a mounted component includes the steps of providing a substrate having an aperture extending through the substrate and having a first capping portion extending at least partially about the aperture, providing a skin having a second capping portion extending at least partially about the aperture, cooperatively engaging the first capping portion and the second capping portion so as to close off the space between the skin and the substrate, and injection molding a foam material into the space between the skin and the substrate.

According to another aspect of the present invention, a method for manufacturing a panel for use with an assembly having a mounted component includes the steps of providing a substrate having an aperture extending through the substrate and having a first capping portion extending at least partially about the aperture, providing a skin having a second capping portion extending at least partially about the aperture, cooperatively engaging the first capping portion and the second capping portion so as to close off the space between the skin and the substrate, injection molding a foam material into the space between the skin and the substrate, and positioning at least a portion of a door handle within the aperture.

### BRIEF DESCRIPTION OF THE DRAWINGS

FIG. 1 is a fragmentary front elevational view of a vehicle door panel embodying the present invention;

FIG. 2 is a greatly enlarged cross-sectional view of the door panel shown in FIG. 1, taken along section lines 2-2 of FIG. 1;

FIG. 3 is a greatly enlarged fragmentary cross-sectional view of the door panel shown in FIG. 1, taken along section lines 3-3 of FIG. 1;

FIG. 4 is an enlarged fragmentary sectional view of a first alternative embodiment of the panel shown in FIGS. 1 and 2;

FIG. 5 is an enlarged fragmentary sectional view of a second alternative embodiment of the panel shown in FIGS. 1 and 2;

FIG. 6 is an enlarged fragmentary sectional view of a third alternative embodiment of the panel shown in FIGS. 1 and 2; and

FIG. 7 is an enlarged fragmentary sectional view of a fourth alternative embodiment of the panel shown in FIGS. 1 and 2.

### DETAILED DESCRIPTION OF THE PREFERRED EMBODIMENTS

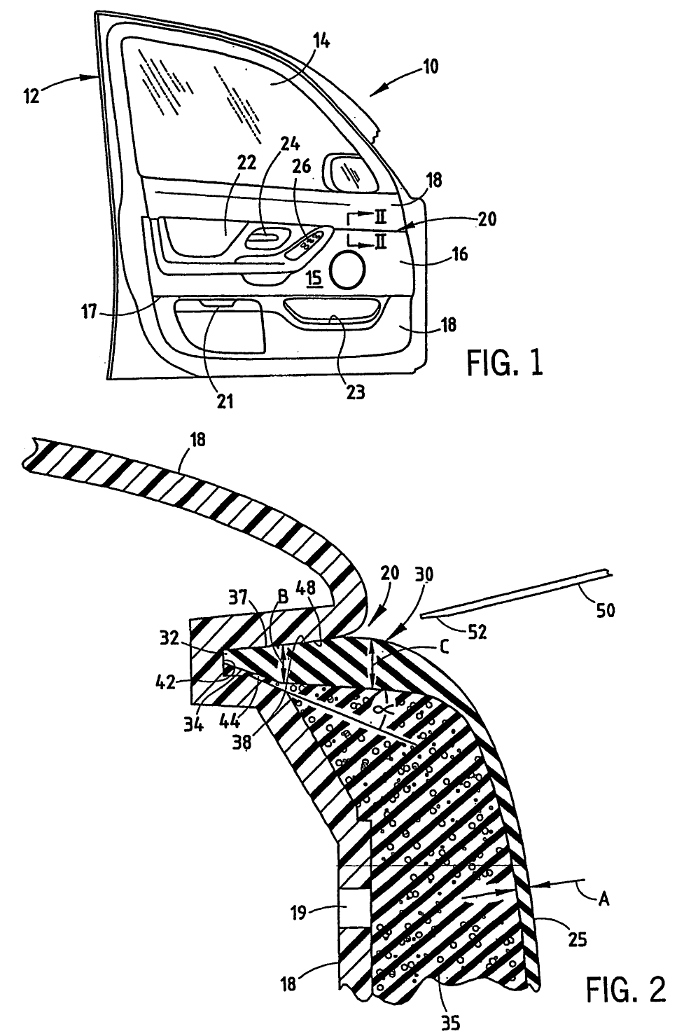

Referring initially to FIG. 1, there is shown a vehicle 10, such as an automobile, and particularly an assembly (shown as a passenger side door 12) thereon. Door 12 is mounted to the vehicle body in a conventional manner and includes a window 14 above a rigid panel 18 with a multi-layered panel 16 joined to panel 18 along a seam 20. Panel 18 forms a substrate behind multi-layered panel 16 and may include an armrest 22 mounted thereon, a door actuating handle 24, and a switch pad 26 for actuating, for example, electrically operated windows, door locks, and the like.

FIG. 2 illustrates a peripheral portion of panel 16 in greater detail. As shown by FIG. 2, panel 16 is formed from panel 18, skin 25 and intermediate layer 35. Panel 18 generally comprises the underlying substrate for panel 16. At the same time, panel 18 extends beyond panel 16 to provide a single-layer structure for remaining portions of door 12. In alternative embodiments, panel 18 may be coextensive with panel 16. Panel 18 is generally made from a sufficiently rigid material so as to maintain its shape. In the particular embodiment illustrated, panel 18 is formed from a suitable polymeric material, such as polypropylene. Those portions panel 18 which extend beyond panel are preferably provided with a textured or decorative outer surface conforming to the interior trim of the vehicle. As a result, portions of panel 18 extending beyond panel 16 may have complementary but different colors as compared to panel 16.

Skin 25 generally comprises a layer which is flexible or deformable. This may be achieved by providing skin 25 with a sufficiently thin dimension or may be achieved by forming skin 25 out of a flexible or deformable material. Skin 25, in conjunction with layer 35, provide panel 16 with a cushioned or soft compressible characteristic. In the particular embodiment illustrated, skin 25 is made of reaction injection molded urethane material or injection molded PVC or TPO.

As best shown by FIG. 2, intermediate layer 35 extends between panel 18 and skin 25. Intermediate layer 35 is preferably compressible in nature in at least one direction. In the particular embodiment illustrated, intermediate layer 35 comprises a foam which is injection molded through apertures 19 in panel 18 in a conventional injection molded process to fill the space between skin 25 and panel 18 to provide a padded or cushioned “feel” for panel 16. Layer 35 preferably has a thickness from about 3 to about 15 millimeters and preferably from about 6 millimeters to about 8 millimeters. In alternative embodiments, the thickness of layer 35 may be varied depending upon the desired padding effect for a given application of panel 16.

Although layer 35 preferably comprises closed cell urethane foam, other conventionally known or future developed foams may be employed. Furthermore, in alternative applications, layer 35 may comprise injected foam which solidifies and hardens to a generally incompressible state. In still other embodiments, panel 16 may include greater than one intermediate layer of compressible or incompressible foam or other material between panel 18 and skin 25.

FIG. 2 further illustrates substrate panel 18 and skin 25 in greater detail along the outer periphery of panel 16, such as along seam 20. As best shown by FIG. 2, panel 16 also includes a peripheral edge 30, which has a thickness significantly greater than the average thickness of the major surface of the skin, which is typically approximately 1 mm, as shown by dimension A in FIG. 2. Edge 30, on the other hand, has a thickness of from at least three to six times greater and, in one embodiment, had a thickness at dimension B of approximately 3 mm. Edge 30 terminates at an end 32 with a corner 34 beveled at angle .alpha. of approximately 20 degrees in the preferred embodiment to allow its easy insertion into a slot 42 integrally formed in the lower panel 18 at seam 20. Panel 18 typically will cover the entire inner surface of the door or other vehicle component with part of the panel being exposed (at 18 in FIG. 1, for example) and the remainder forming a substrate for a cushioned outer skin 25 and other components mounted to the door such as storage compartments 21 and 23 shown in FIG. 1. Slot 42 includes a tapered wall 44 with a slight gap for easily receiving the tapered corner 34 of skin 25. The depth of slot 42 is sufficient to receive the tapered end 32 of skin 30 which has a slightly increasing thickness to approximately 4 mm at its dimension C such that the end 32 of skin 25 is significantly thicker than the overall major surface area of panel 16 at the periphery of its intersection with panel 18. A similar interconnection exists for the remaining periphery of panel-forming skin 25 at, for example, seam 17 of door 12.

Once the skin 25 is molded into a shape for a particular vehicle component, its thicker peripheral edges are tucked into the peripheral slot 42 in the substrate panel 18 by a tool member 50 shown schematically in FIG. 2. The space between skin 25 and substrate 18 is injection-molded through apertures 19 in panel 18 with layer 35. By providing an enlarged, thicker end 30 around the periphery of panel forming skin 25, the peripheral edge can be tucked into the slot of panel 18 without the need for sealing clamps spaced around the periphery during the injection molding process inasmuch as the layer 35 injected behind the skin 25 self-seals the end 32 in slot 42 of panel 18, providing clean and neat appearing interfaces 17 and 20 at the junction of skin 25 and panel 18.

Tooling for the system shown is relatively inexpensive as compared to the complicated, multi-clamp tooling required for prior art systems. For example, tool 50 (shown schematically in FIG. 2) may be in the form of a tray which holds the injection-molded skin 25 and raises the skin vertically into position against the panel 18, tucking the thickened ends 32 into slots 42 without the need for holding clamps. Tool 50 may be in the form of a tray with a peripheral edge 52 for supporting the peripheral edge 30 of skin 25 as it is pushed into place in peripheral slot 42 of substrate 18 and thereafter urethane foam is injection molded through apertures 19 in substrate 18 to complete the integrated soft-skin panel of, for example, door 12.

The back pressure provided by the closed-cell urethane foam material injected into the space between panel 18 and skin 25 provides a seal at the interface 37 between surface 38 (FIG. 2) of skin 25 and inner surface 48 of panel 18 to prevent foam from leaking from seams 17 and 20. The system of the present invention, therefore, provides an improved skin design for forming a decorative panel for a vehicle as well as a method of manufacturing a panel by tucking the skin into a receiving slot and injection molding a cushioning material behind the skin which self-seals during the injection molding process. Thus, with the method and apparatus of the present invention, a trim panel for a vehicle can be inexpensively manufactured and maintain the desired appearance of similar panels made utilizing a much more expensive process.

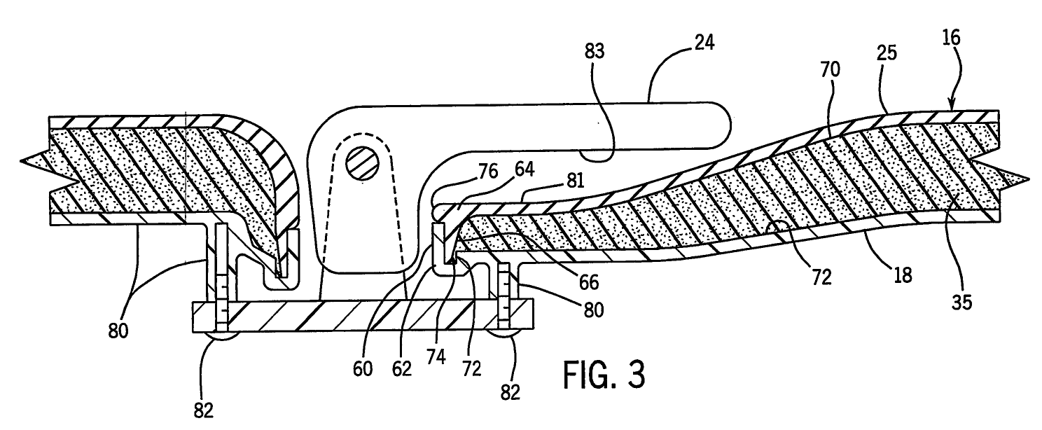

FIG. 3 is a sectional view of door 12 illustrating adjacent portions of panel 16 and door-actuating handle 24 in greater detail. As best shown by FIG. 3, panel 18 forms an aperture 60 configured to receive a mounted component such as handle 24. Panel 18 includes at least one capping portion 62 which extends proximate to and about aperture 60. Skin 25 includes a capping portion 64 proximate to and about aperture 60. Capping portions 62 and 64 are configured to cooperate with one another so as to conceal and close off layer 35 between panel 18 and skin 25. In particular, at least one of portions 62 and 64 includes a sealing surface 66 that extends between and bridges inner skin surface 70 and inner substrate surface 72. Although surface 66 is illustrated as being provided solely by capping portion 64 of skin 25, surface 66 may alternatively be provided solely by capping portion 62 of substrate 18 or may be provided in part by both capping portions 62 and 64.

FIG. 3 illustrates one preferred arrangement wherein portions 62 and 64 cooperate to cap or close off layer 35. In the embodiment shown, portion 62 is configured to receive portion 64. In particular, portion 62 provides a channel 72 which receives an end 74 of portion 64. In the particular embodiment wherein portion 62 extends completely about aperture 60 so as to encircle aperture 60, channel 72 also extends completely about aperture 60. In the embodiment shown, channel 72 is generally annular in shape. In alternative embodiments, aperture 60 may be formed and bounded by multiple panels being either multi-layered like panel 16 or comprising generally a single layer like panel 18, wherein portions 62 and 64 may only partially extend about aperture 60. Although portion 62 is illustrated as receiving portion 64, this relationship may be reversed wherein portion 64 is provided with a channel that receives an end or tongue of portion 62.

In the particular embodiment illustrated, channel 72 and end 74 are configured similar to edge 30 and slot 42 at the outer periphery of panel 16. Although less desirable, channel 72 and end 74 may have other configurations.

As further shown by FIG. 3, portion 64 additionally includes an extension 76 which projects beyond end 66 towards aperture 60. Extension 76 preferably has a length sufficient such that extension 76 overlies portion 62 of substrate 18 to at least partially conceal substrate 18. In alternative embodiments, extension 76 may be omitted.

As further shown by FIG. 3, panel 18 additionally includes bosses 80. Bosses 80 generally comprise structures configured to engage and to mount a component such as handle 24. In the particular embodiment illustrated, bosses 80 generally comprise projections integrally formed as part of panel 18 and extending from panel 18 in a direction away from skin 25. Bosses 80 are generally configured to receive fasteners 82 so as to couple handle 24 to panel 18 and to panel 16. As a result, bosses 80 enable handle 24 to be mounted to panel 16 without requiring additional apertures or holes through panel 18, through layer 35 or through skin 25, reducing manufacturing complexity and increasing the structural strength of panel 16 about aperture 60.

Overall, panel 16 provides a clean, lower cost and easily manufactured multi-layer structure about a mounted component such as a handle. Capping portions 62 and 64 close off intermediate layer 35. At the same time, bosses 80 eliminate the need for additional holes to extend through substrate 18, layer 35 and skin 25 about aperture 60 for mounting the component. Unlike previous panels which required the use of a bezel about an aperture to: (1) cap off the foam layer about the hole cut through the panel, (2) to conceal the additional mounting holes extending through the panel and to (3) mount a component to the panel, panel 16 eliminates the need for such a bezel. Not only is manufacturing cost and complexity reduced, but panel 16 enables a soft, compressible surface 81 opposite bosses 80, to be provided in close proximity to the aperture through which the component extends between the underlying substrate panel 18 and the portion 83 of component 24 that overlaps and extends opposite substrate panel 18. This is particularly beneficial in those applications where the component supported by panel 16 comprises a handle, latch or the like which must be grasped and manipulated by a passenger's hands.

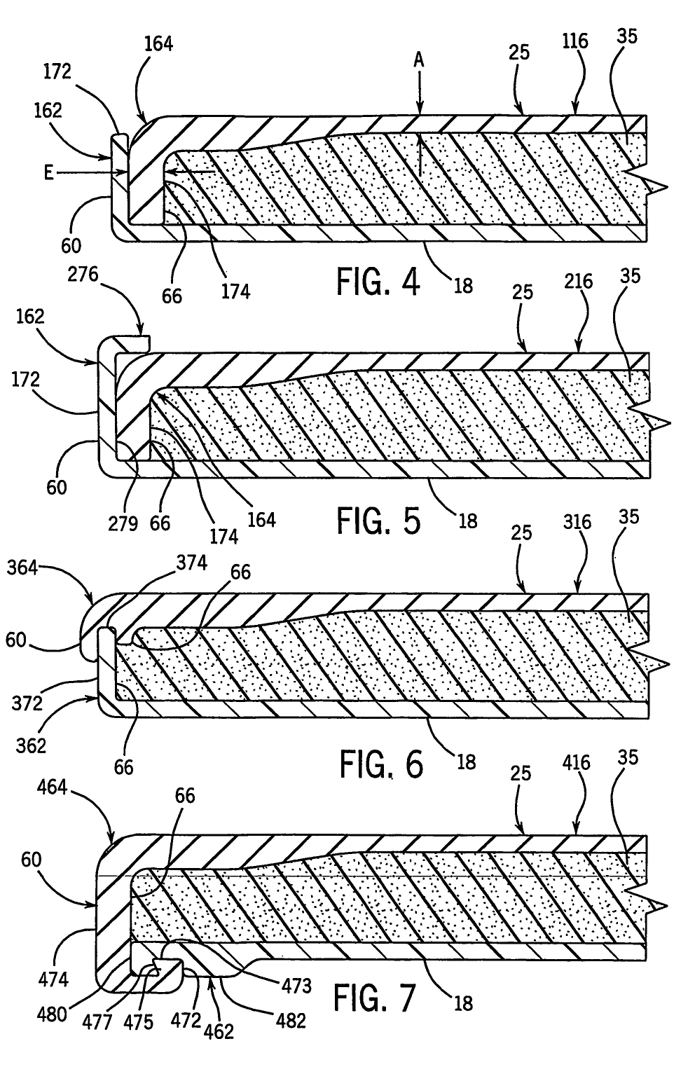

FIGS. 4-7 schematically illustrate but a few of several alternative capping portions 62 and 64 of substrate 18 and skin 25, respectively, that may be employed. FIG. 4 illustrates panel 116, an alternative embodiment of panel 16. Panel 116 is similar to panel 16 except that panel 116 includes capping portions 162 and 164 in lieu of capping portions 62 and 64. Capping portion 162 is similar to capping portion 62 except that capping portion 162 omits channel 72. Capping portion 164 is similar to capping portion 64 except that capping portion 164 omits extension 76. Capping portions 162 and 164 each include end portions 172 and 174, respectively, that engage one another to cap off or enclose layer 35. As shown by FIG. 4, end portion 174 has a thickness E generally greater than the thickness A of the remainder of skin 25. This increased thickness assists in maintaining engagement of end portions 172 and 174.

FIG. 5 schematically illustrates panel 216, an alternative embodiment of panel 16. Panel 216 is substantially identical to panel 116 except that panel 216 additionally includes substrate extension 276. Substrate extension 276 projects from end portion 172 away from aperture 60 so as to form a channel 279. Channel 279 faces away from aperture 60 and receives end 174 of capping portion 164. Channel 279 further assists in retaining capping portions 162 and 164 in an engaged relationship.

FIG. 6 schematically illustrates panel 316, an alternative embodiment of panel 16. Panel 316 is similar to panel 16 except that panel 316 includes capping portions 362 and 364. Capping portion 362 is similar to capping portion 62 except that capping portion 362 omits channel 72 and merely includes an end 372. Capping portion 364 includes a channel 374 configured to receive end 372. In the particular embodiment illustrated wherein panel 316 extends completely about aperture 60, channel 374 also extends completely about aperture 60 and is preferably annular in shape. Capping portion 364 preferably has a thickness about channel 374 that is greater than the thickness of the remaining portions of skin 25. As shown by FIG. 6, channel 374 receives end 372 such that portions 362 and 364 cooperate to cap off layer 35 about aperture 60.

FIG. 7 schematically illustrates panel 416, an alternative embodiment of panel 16. Panel 416 is similar to panel 16 except that panel 416 alternatively includes capping portions 462 and 464 about aperture 60. Capping portion 462 is generally formed as part of substrate panel 18 about aperture 60 and includes an exterior channel 472 and a detent 473. Capping portion 464 is formed as part of skin 25 and preferably has a thickness greater than the remainder of skin 25.

Capping portion 464 generally includes a wrap-around portion 474, an end portion 475 and a detent-engaging portion 477. Wrap-around portion 474 at least partially provides surface 66 and wraps about end 480 of panel 18. In the particular embodiment illustrated, wrap-around portion 474 overlies an exterior side 482 of panel 18. End portion 475 extends from wrap-around portion 474 into channel 472.

Detent-engaging portion 477 extends from end 475 and is configured to engage and be received within detent 473 of panel 18. Detent-engaging portion 477 preferably snaps into place within detent 473 to securely retain capping portions 462 and 464 together. In the preferred embodiment, either or both of detent-engaging portion 477 or surfaces forming detent 473 are formed from a resilient flexible material enabling flexing such that detent-engaging portion 477 may be snapped into detent 473.

Although less desirable, detent 473 and detent-engaging portion 477 may be omitted. In other embodiments, capping portion 462 of panel 18 may be provided with a detent-engaging portion, such as a projection, while capping portion 464 of skin 25 is provided with a detent, such as a notch. In the preferred embodiment, detent 473 and detent-engaging portion 477 extend completely about aperture 60. In alternative embodiments, detent 473 may be comprised of multiple spaced notches at least partially about aperture 60 or detent-engaging portion 477 may consist of a plurality of spaced projections at least partially about aperture 60.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments and set forth in the following claims is manifestly intended to be as broad as possible. For example, unless specifically otherwise noted, the claims reciting a single particular element also encompass a plurality of such particular elements.

What is claimed is:

1. A panel for use in an assembly having a mounted component, the panel comprising:
a substrate having an aperture extending through the substrate and a first capping portion at least partially about the aperture, wherein the aperture is configured to receive the mounted component;
a skin having a second capping portion at least partially about the aperture; and
at least one compressible layer between the substrate and the skin, wherein the first capping portion and second capping portion cooperatively engage one another to close off the at least one compressible layer between the substrate and the skin.

2. The panel of claim 1, including at least one boss coupled to and extending from the substrate opposite the skin, wherein the at least one boss is configured to mount the mounted component to the substrate.

3. The panel of claim 1, wherein the mounted component comprises a handle and wherein the aperture is configured to receive the handle.

4. The panel of claim 1, wherein the at least one compressible layer includes a foam layer injection molded between the substrate and the skin.

5. The panel of claim 1, wherein one of the first capping portion and the second capping portion includes a channel and wherein the other of the first capping portion and the second capping portion includes an end received within the channel.

6. The panel of claim 5, wherein the channel extends completely about the aperture.

7. The panel of claim 1, wherein the second capping portion has a first thickness and wherein a remainder of the skin has a second lesser thickness.

8. The panel of claim 1, wherein one of the first capping portion and the second capping portion includes a detent and wherein the other of the first capping portion and the second capping portion includes a detent-engaging portion.

9. The panel of claim 1, wherein the first capping portion and the second capping portion at least partially overlap one another between the substrate and the skin.

10. An assembly comprising:
a substrate having an aperture extending through the substrate and a first capping portion at least partially about the aperture;
a skin having a second capping portion;
at least one layer between the substrate and the skin, wherein the first capping portion and second capping portion cooperatively engage one another to close off the at least one compressible layer between the substrate and the skin; and
a component extending through the aperture.

11. The assembly of claim 10, wherein the component is mounted to the substrate.

12. The assembly of claim 10 including at least one boss coupled to and extending from the substrate opposite the skin, wherein the component is mounted to the at least one boss.

13. The assembly of claim 10, wherein the component comprises a handle.

14. The assembly of claim 10, wherein the at least one compressible layer includes a foam layer injection molded between the substrate and the skin.

15. The assembly of claim 10, wherein the first capping portion and the second capping portion at least partially overlap one another between the substrate and the skin.

16. A vehicle door assembly comprising:
a substrate having an aperture extending through the substrate;
a handle extending through the aperture and having a portion opposite the substrate; and
a compressible surface coupled to the substrate and extending in close proximity to the aperture between the substrate and the portion of the handle opposite the substrate.

17. The assembly of claim 16 including at least one boss coupled to and extending from the substrate, wherein the handle is mounted to the at least one boss.

18. The assembly of claim 16 including:
a skin; and
at least one compressible layer between the substrate and the skin.

19. The assembly of claim 18, wherein the substrate includes a first capping portion at least partially about the aperture, wherein the skin has a second capping portion cooperatively engaging the first capping portion to close off the at least one compressible layer between the substrate and the skin.

20. The assembly of claim 18, wherein the at least one compressible layer includes a foam layer injection molded between the substrate and the skin.

21. A method for manufacturing a panel for use with an assembly having a mounted component, the method comprising:
providing a substrate having an aperture extending through the substrate and having a first capping portion extending at least partially about the aperture;
providing a skin having a second capping portion extending at least partially about the aperture;
cooperatively engaging the first capping portion and the second capping portion so as to close off a space between the skin and the substrate; and
injection molding a foam material into the space between the skin and the substrate.

22. A method for manufacturing a vehicle door assembly, the method comprising:
providing a substrate having an aperture extending through the substrate and having a first capping portion extending at least partially about the aperture;
providing a skin having a second capping portion extending at least partially about the aperture;
cooperatively engaging the first capping portion and the second capping portion so as to close off a space between the skin and the substrate; and;
injection molding a foam material into the spaces between the skin and the substrate; and
positioning at least a portion of a door handle within the aperture.

23. The method of claim 22 including mounting the door handle to the substrate.
